(19) United States
(12) Patent Application Publication
(10) Pub. No.: US 2007/0025317 A1
(43) Pub. Date: Feb. 1, 2007

(54) Signaling for bit allocation in a wireless lan

(76) Inventors: Edgar Bolinth, Korschenbroich (DE); Ludger Marwitz, Bocholt (DE)

Correspondence Address: BELL, BOYD & LLOYD, LLC, P. O. BOX 1135, CHICAGO, IL, 60690-1135, US

(21) Appl. No.: 10/556,856

(22) PCT Filed: May 11, 2004
(86) PCT No.: PCT/EP04/50761

§ 371 Date: Nov. 14, 2005

(30) Foreign Application Priority Data
May 12, 2003 (EP) 03010624.9

(51) Int. Cl. H04B 7/212

(52) U.S. Cl. 370/347

(57) ABSTRACT

The invention provides that, in the event of a decentrally or centrally organized access to the transmission medium, preferably an IEEE 802.11 system, pilot signals are transmitted from the transmitter to the receiver, and the allocation table is subsequently calculated by the receiver on the basis of the received pilot symbols. The allocation table is transmitted from the receiver to the transmitter so that the subsequent data exchange can take place based on the allocation table.

### FIELD OF TECHNOLOGY

The present invention relates to a method for data transmission in a communication system having access organized on a centralized or decentralized basis to the transmission medium using a plurality of transmission modes. More particularly, the present invention relates to a signaling scheme for adaptive modulation in a CSMA/CA (Carrier Sense Multiple Access Collision Avoidance) based access system.

### BACKGROUND

A serious problem with mobile radio transmission is the frequency selectivity of the mobile radio channels. The frequency selectivity, induced by multipath propagation with great delay differences, causes strong linear distortions of the receive signal, necessitating the use of complex and expensive equalizers or a Viterbi detection scheme. A suitable means of counteracting the disadvantages of frequency-selective channels is the technique known as adaptive modulation (AM), which is described in more detail below.

Adaptive modulation is used in OFDM (Orthogonal Frequency Division Multiplexing) systems to reduce the disadvantages of frequency-selective fading channels. It improves the data throughput but also the range. With this technique, the data is transmitted via individual subcarriers.

The principle of adaptive modulation will be briefly explained below. The transmitter transmits data to a receiver via the radio channel. In the transmitter, the data to be sent is initially coded by a coder and interleaved by an interleaver. The data is then modulated using a different modulation level depending on the channel characteristics. Suitable modulation alphabets/methods for this are, for example, the known amplitude/phase-shift keying methods BPSK, QPSK, 16 QAM, 64 QAM etc. with the respective modulation levels 1, 2, 4 and 6. In the case of a high signal/noise ratio the respective subcarrier are modulated at a high bit number, whereas in the case of a low signal/noise ratio a low bit number is sufficient. The signal/noise ratio is usually estimated in the receiver and converted for the individual subcarriers into what is referred to as a bit-loading table. A bit-loading table of said type can contain, for example, information relating to the signal/noise ratio or alternatively the requested modulation level for each individual subcarrier. The aforementioned bit-loading table is transmitted to the transmitter so that the latter can control a demultiplexer DEMUX and a multiplexer MUX for the adaptive modulation accordingly.

The demultiplexer DEMUX routes the bit stream received from the interleaver to the modulator MOD1, . . . , MODn−1, MODn allocated to a specific modulation level in each case. In this arrangement the modulator MOD1 can be, for example, a BPSK modulator and the modulator MODn can be a 64 QAM modulator. The pointers received after the respective modulation are then subjected to an inverse fast Fourier transformation IFFT by the multiplexer MUX, which is likewise controlled via the bit-loading table. There, the pointers are converted to the respective subcarrier for the transmission and subsequently modulated up onto the carrier frequency.

In the receiver, this process is executed essentially in reverse. First the data is obtained from the individual subcarriers as pointers via a fast Fourier transformation. A subsequent demultiplexer DEMUX allocates the data to the appropriate demodulator in accordance with the bit-loading table. The bit stream obtained from the demodulator DEMOD1, . . . , DEMODn−1, DEMODn is supplied to a deinterleaver and channel decoder via a multiplexer MUX.

As already mentioned, for the purpose of adaptive modulation the desired bit-loading table has to be transmitted from the transmitter to the receiver. An important point here is that the bit-loading tables typically have to be calculated in the receiver on the basis of RSSI (Radio Signal Strength Indication) or SNR (Signal to Noise/Interference Ratio) and transmitted to the transmitter. For a TDD (Time Division Duplex) scheme, a WSS (White Sense Stationary) channel is assumed for a period of time in which the bit-loading table is valid.

The medium access control (MAC) and physical characteristics for radio LAN systems are specified in the IEEE 802.11a standard. A medium access control unit conforming to this standard is required to support the components of a physical layer as a function of the availability of the spectrum with regard to their authorization to access the transmission medium.

In principle two coordination options are available for access: the centralized and the decentralized access function. With the centralized access function (Point Coordination Function, PCF), the coordination function logic is only active in one station or, as the case may be, in one terminal of a group of terminals (Basic Service Set, BSS) while the network is in operation. Conversely, with a decentralized access function (Distributed Coordination Function, DCF) the same coordination function logic is active in every station or, as the case may be, every terminal of the terminal group while the network is in operation.

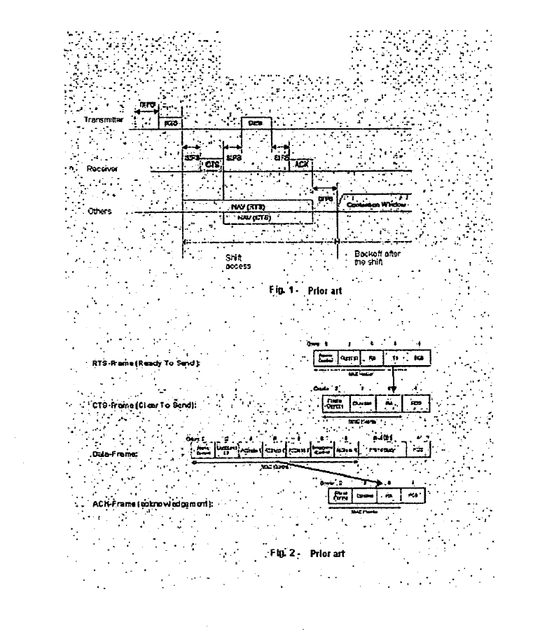

To illustrate this, FIG. 1 shows the data frame structure for the data exchange of a decentralized access system (DCF) conforming to the IEEE 802.11 standard. Reference is made to the standard with regard to the abbreviations and terms used in the present document. According to FIG. 1 the following are involved in the communication: a transmitter, a receiver and others. After a waiting period, referred to as the DCF Interframe Space (DIFS), the transmitter transmits an RTS (Ready to Send) signal to the network. After a brief waiting period (Short Interframe Space, SIFS) the receiver sends the CTS (Clear to Send) signal, by means of which it indicates its readiness to receive. After a further brief waiting period SIFS, the transmitter sends into the network the data (“Data”) to be transmitted. After the transmission and a waiting period SIFS the receiver confirms the receipt of the data with the acknowledgement message ACK (Acknowledge). In this case the waiting periods SIFS and DIFS amount to 16 μs and 34 μs respectively.

In the case of other communication partners, the vector NAV (Network Allocation Vector) is set on the initiative of the RTS or CTS signal, where the vector specifies for how long a transmission to the radio medium (Wireless Medium) cannot be performed by the respective station.

Access to the radio system is only possible again after the waiting period DIFS has elapsed following the acknowledgement ACK of the receiver. In the subsequent window, known as the “contention window”, a delay by a random backoff time takes place in order to avoid collisions.

FIG. 2 shows the frame or, as the case may be, data packet formats of the frames shown in FIG. 1. An important aspect in this context is the interaction between transmitter and receiver and hence the respective addressing. Thus, for example, the transmitter address TA can be found once again coded with six octets in the RTS frame. Similarly, the receiver address is coded with six octets in the CTS frame. The data frame sent by the transmitter contains the destination address in the address block “Address 2”. The ACK frame returned by the receiver for the purpose of acknowledgement in turn contains the receiver address RA, so the transmitter can unequivocally assign the acknowledgement.

WO 02/082751 discloses a method which, in a closed loop for channel access methods, enables transmit power control as well as link adaptation in conjunction with an RTS/CTS based channel access scheme.

### SUMMARY

Accordingly, a method is disclosed herein which guarantees a simple implementation of an adaptive modulation.

Under a preferred embodiment, a method for data transmission in a communication system has a plurality of stations with organized access to a transmission medium using a plurality of transmission modes, by sending of at least one pilot signal from the transmitter to the receiver. “Transmitter” is understood to mean a station which represents the source of a current transmission and ‘receiver” is understood to mean a station which represents the sink of a transmission. Accordingly, any station can be a transmitter or receiver, depending on its current status and should also be in a position to perform the steps according to the disclosure herein for both roles. Furthermore, an allocation table/loading table is calculated with respect to the transmission modes by the receiver on the basis of the received pilot signals. The allocation table is sent to the transmitter by the receiver and the data signals are sent using one of the transmission modes according to the allocation table from the transmitter to the receiver or from the receiver to the transmitter.

Thus, adaptive modulation can also be used in multiple access systems, for example the CSMA system (Carrier Sense Multiple Access) on the basis of the bit-loading signaling scheme according to the invention. However, for adaptive modulation it is important that the desired bit-loading tables are transmitted correctly from the receiver to the transmitter. If this is not the case, serious problems can occur. It is through the use of the bit-loading signaling scheme that the transmission of adaptively modulated data packets is made possible the transmission being less susceptible to packet errors as a result of the adaptive modulation.

The present disclosure can be applied particularly advantageously to a CSMA/CA (Collision Avoidance) scheme with decentralized access wherein use is made of the RTS (Ready to Send) signals, CTS (Clear to Send) signals and NAV (Network Allocation Vector) for reservation of the common medium for the data transmission and where applicable also the acknowledgement message ACK (Acknowledge) for confirming reception of the data. Thus, at a basic level adaptive modulation can be used for an OFDM (Orthogonal Frequency Division Multiplexing) system or an MC/CDMA (Multi Carrier Code Division Multiple Access) system which are based on CSMA/CA access.

As already indicated, the method according to the invention can be advantageously used for IEEE 802.11-compliant standardized systems. In such systems, pilots for calculating bit-loading tables can be sent in the RTS signal for decentralized access. Preferably, the transmitter inquires in the RTS signal at the receiver whether the latter is capable of adaptive modulation and if necessary able to perform additional functions within the framework of the physical layer, referred to as the PHY extensions.

In a similar manner it is preferable if the receiver inquires at the transmitter in the CTS signal about the capability to perform adaptive modulation and where necessary further PHY extensions. At the same time the receiver can send the allocation table or, as the case may be, bit-loading table calculated on the basis of the pilots in the CTS signal to the transmitter.

For bidirectional data communication using adaptive modulation between two communication terminals it should be pointed out that each terminal can be both a transmitter and receiver. In the context of the IEEE 802.11a standard the bit-loading table can be transmitted with the aid of two OFDM data symbols, each of which consists of 24 data bits (or, as the case may be, of 48 code bits in each case coded using rate R=0.5).

The use of a specific PHY extension can be confirmed in the CTS signal of the receiver.

Both in the case of centralized and in the case of decentralized access, the data transmission should be performed using a fixed modulation scheme as long as no current bit-loading table is present at the transmitter or, as the case may be, receiver.

Both systems, the system having decentralized access and the system having centralized access, can be time-interleaved, enabling the specific components in each case to be used in parallel with one another.

In particular with centrally organized access, preferably an IEEE 802.11 system with a Point Coordination Function (PCF) or a Hybrid Coordination Function (HCF), an improvement is produced in that already with the transmission of an allocation table the following data is adaptively modulated accordingly.

### DETAILED DESCRIPTION OF THE DRAWINGS

The various objects, advantages and novel features of the present disclosure will be more readily apprehended from the following Detailed Description when read in conjunction with the enclosed drawings, in which:

FIG. 1 illustrates a signaling scheme of a DCF (Distributed Coordination Function) data exchange according to the IEEE 802.11 standard;

FIG. 2 illustrates the data packet structure for the data exchange according to FIG. 1;

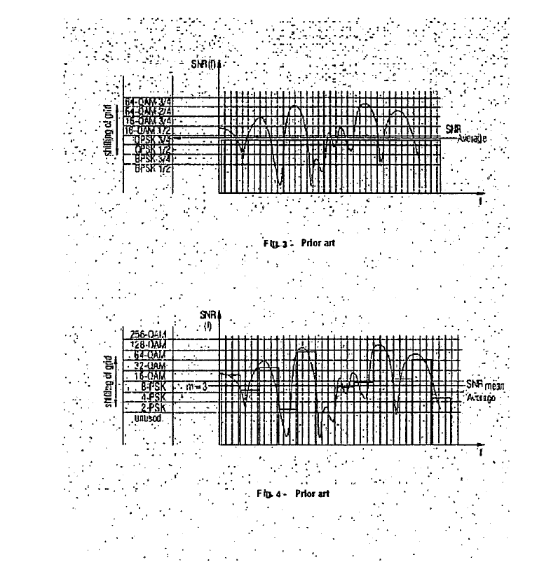

FIG. 3 illustrates the conventional modulation of OFDM subcarriers;

FIG. 4 illustrates the adaptive modulation of OFDM subcarriers;

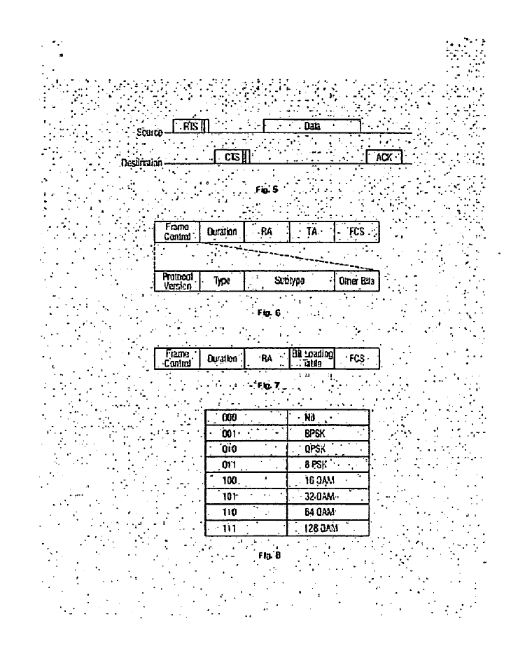

FIG. 5 illustrates in schematic form an extension of “Request To Send” (RTS) and “Clear To Send” (CTS) frames under an exemplary embodiment;

FIG. 6 illustrates an exemplary format of an RTS frame under the embodiment;

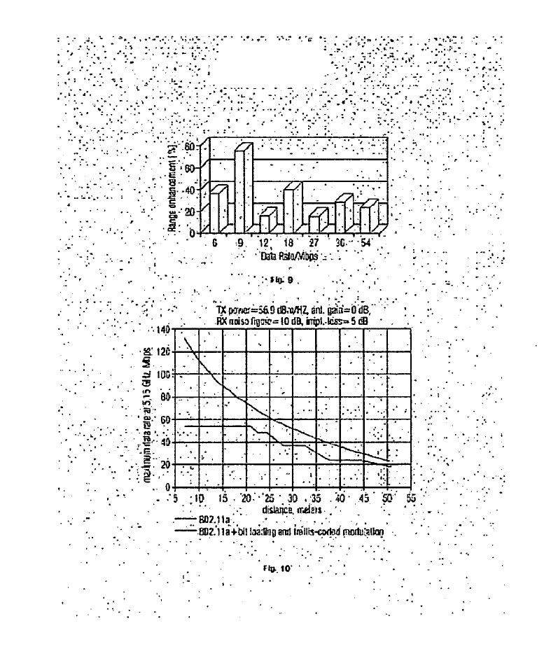

FIG. 7 illustrates an exemplary frame format of a CTS frame under the embodiment;

FIG. 8 illustrates an exemplary embodiment of a list (table) with allocations for the coding or modulation, with each allocation defining a coding and modulation used for a specific subcarrier;

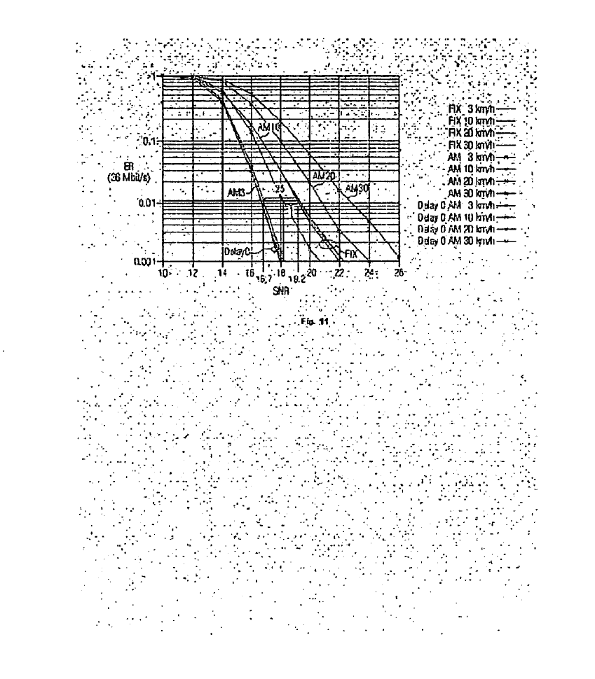

FIG. 9 illustrates a range achievable under the exemplary embodiment;

FIG. 10 illustrates a data rate achievable under the exemplary embodiment;

FIG. 11 illustrates a comparison between conventional and adaptive modulation based on the speed of a moving mobile station of the communication system.

### DETAILED DESCRIPTION

As shown in FIG. 3, all subcarriers of an “orthogonal frequency division multiplex” OFDM based communication system which uses conventional modulation use the same modulation alphabet.

Whereas in an OFDM communication system that uses adaptive modulation, groups of adjacent subcarriers are formed for modulation of the subcarriers, for each of which modulation alphabets are assigned individually for each group.

According to the present disclosure, a small extension as shown in FIG. 5 in the RTS/CTS frames is preferably a part of an implementation of a signaling method within a communication system using adaptive modulation.

FIG. 6 illustrates an extended RTS frame according to the embodiment in detail. As can be recognized from this, the extension can be implemented by occupying unused bit combinations of the frame, for example the “Subtype” field, in order to signal within the RTS frame that a station (terminal) is able to use adaptive modulation. In the example shown, this is signaled by the unused bit combination 0011 in the “Subtype” field.

A station acting as the sink for the transmission thereupon measures the subcarriers of the RTS frame and responds with a bit-loading table resulting herefrom. The aforementioned table that is used for the adaptive modulation is then sent within a CTS frame to the station acting as the source of the transmission, i.e. the above mentioned station initiating the transmission. This sequence can be derived from FIG. 7, where the “source station” subsequently modulates data transmitted by it in accordance with the bit-loading table.

FIG. 8 shows an example of a bit-loading table of the aforementioned type. As can be seen, it can be derived from the allocation information contained in said table that, for example, in the case of an addressing of three bits per subcarrier group for a transmission, eight PHY modes exist (when four bits are addressed, accordingly—2 Address bits—16 PHY modes). In addition, a coding for each of the 16 subcarrier groups (bundle), for example a 3 bit/subcarrier group×16 groups/OFDM symbol=48 bits=6 bytes per allocation table, is also derived. If the allocation table is transmitted via 48 OFDM subcarriers which are modulated using BPSK and transmitted at a code rate of R=½, 2 OFDM symbols are required for this.

The result—as shown in FIG. 9—is that when adaptive modulation is used, an outstanding increase in the range can be achieved through use of the exemplary method.

In addition, a significant increase in the data throughput is also achieved.

It can be seen from FIG. 11 that adaptive modulation surpasses conventional (fixed) modulation at speeds of pedestrians, whereas the reverse is true at speeds greater than or equal to 15 km/h.

As shown, through the advantageous use of adaptive modulation, a substantial increase in throughput and rate can be achieved on the basis of the RTS/CTS according to the invention, the inventive approach additionally being characterized by the simplicity of its implementation.

It should be understood that the various changes and modifications to the presently preferred embodiments described herein will be apparent to those skilled in the art. Such changes and modifications can be made without departing from the spirit and scope of the present disclosure and without diminishing its intended advantages. It is therefore intended that such changes and modifications be covered by the appended claims.

1-19. (canceled)

20. A method for data transmission in a communication system having a plurality of stations with organized access to a transmission medium using a plurality of transmission modes, comprising:
sending at least one pilot signal from the transmitter to the receiver,
calculating an allocation table with respect to the transmission modes of the receiver detected on the basis of the received pilot signals,
sending the allocation table from the receiver to the transmitter; and
sending the data signals using one of the detected transmission modes according to the allocation table from the transmitter to the receiver or from the receiver to the transmitter,
wherein the allocation table includes a bit-loading table for adaptive modulation or extension data for extensions of the media access layer “MAC Layer” that extend beyond the IEEE 802.11a standard or other standards of the physical layer.

21. The method as claimed in claim 20, wherein the organized access is performed on a decentralized basis.

22. The method as claimed in claim 20, wherein the pilot signals are transmitted in an RTS message.

23. The method as claimed in claim 20, further comprising transmitting an RTS message inquiry from the transmitter to determine adaptive modulation or extensions of the media access layer MAC Layer that extend beyond the IEEE 802.11a standard.

24. The method as claimed in claim 23, further comprising transmitting a CTS message acknowledgement from the receiver to specify adaptive modulation or extensions of the media access layer that go beyond the IEEE 802.11a standard.

25. The method as claimed in claim 20, wherein the allocation table of the receiver is transmitted in a CTS message.

26. The method as claimed in claim 20, wherein the transmitter and receiver comprise a communication terminal and wherein the allocation table is transmitted from the receiver to the transmitter or vice versa.

27. The method as claimed in claim 20, wherein the allocation table is used in the data transmission packet.

28. The method as claimed in claim 20, wherein at least one data symbol is used for the transmission of the allocation table.

29. The method as claimed in claim 20, wherein a specific extension of the media access layer that goes beyond the IEEE 802.11a standard is acknowledged in a CTS message.

30. A method as claimed in claim 20, wherein the organized access is performed on a centralized basis.

31. The method as claimed in claim 30, wherein the data symbols are modulated using a fixed modulation scheme as long as no allocation table in respect of the transmission modes is present.

32. The method as claimed in claim 30, wherein the allocation table includes a bit-loading table for adaptive modulation and/or extension data for extensions of the physical layer which extend beyond the IEEE 802.11a standard or other standards of the physical layer.

33. The method as claimed in claim 20, wherein the communication system is a CSMA system, conforming to the IEEE802.11 standard.

34. The method as claimed in claim 20 wherein the transmission modes are formed at least in part from an adaptive modulation.

35. The method as claimed in claim 20, wherein the data signals are time-interleaved.

36. The method as claimed in claim 20 wherein the allocation table addresses the modulation levels via GRAY-coded bits.

37. The method as claimed in claim 20 wherein unused bit combinations of the “Type” or “Subtype” field of the IEEE 802.11 standard are used to implement extensions of the RTS/CTS signaling.
